(19) United States
(12) Patent Application Publication
(10) Pub. No.: US 2019/0137978 A1
(43) Pub. Date: May 9, 2019

(54) Intelligent Umbrella and/or Robotic Shading System Mechanical and Tracking Improvements

(71) Applicant: Shadecraft, Inc., Pasadena, CA (US)

(72) Inventor: Armen Sevada Gharabegian, Glendale, CA (US)

(21) Appl. No.: 16/118,385

(22) Filed: Aug. 30, 2018

Related U.S. Application Data
(60) Provisional application No. 62/552,976, filed on Aug. 31, 2017.

(51) Int. Cl. G05B 19/4155; E04H 15/28; E04H 15/02; A45B 23/00

(52) U.S. Cl. CPC G05B 19/4155; E04H 15/28; E04H 15/02; G05B 2219/36517; A45B 2023/0012; A45B 2200/1009; A45B 23/00

(57) ABSTRACT

A method of orienting an umbrella includes obtaining a current location for an umbrella and communicate the current location to one or more processors, capturing a current time of day via a clock in the umbrella and communicating the current time to the one or more processors, calculating an elevation angle and azimuth angle of a sun utilizing the current time and the location, capturing a reading from a compass in the umbrella to determine a directional heading or an angular heading for a top section of the umbrella, and rotating a core assembly and an upper assembly of the umbrella about a base of the umbrella. The method further comprises utilizing a sensor assembly to detect a location of a magnet in the base of the umbrella. The method further comprises includes aligning a top of umbrella with the magnet in the base of the umbrella.

### RELATED APPLICATIONS

This application claims priority to U.S. provisional patent application Ser. No. 62/552,976, filed Aug. 31, 2017 and entitled “Intelligent Umbrella and/or Robotic Shading System Mechanical and Tracking Improvements,” the disclosure of which is hereby incorporated by reference.

### BACKGROUND

### 1. Field

The subject matter disclosed herein relates to improvements in intelligent umbrella and/or robotic shading system mechanical assemblies and tracking methods for use in intelligent umbrellas and/or robotic shading systems.

### 2. Information/Background of the Invention

Intelligent umbrellas and robotic shading systems have limitations as to being portable and also determining location. Accordingly, a need exists for improved mechanical assemblies being utilized in intelligent umbrellas or robotic shading systems and for such devices to be accurately located.

### BRIEF DESCRIPTION OF THE DRAWINGS

FIG. 1 illustrates an improved actuator assembly according to embodiments;

FIG. 2 illustrates an umbrella utilizing a hinging assembly for performing elevation rotation according to embodiments;

FIG. 3A illustrates an actuator and associated structures in a middle portion of an intelligent umbrella or parasol according to embodiments;

FIG. 3B illustrates movement of a portion of an upper core assembly after a linkage assembly has pushed a hinging assembly (not shown in FIG. 3B) to an extended position according to embodiments;

FIG. 4 illustrates an upper portion of an intelligent umbrella or robotic shading system according to embodiments;

FIG. 5 illustrates operation of an arm linking and support assembly according to embodiments;

FIG. 6 illustrates an upper portion of an intelligent umbrella or robotic shading system according to embodiments;

FIG. 6A illustrates an upper portion of an intelligent umbrella and/or robotic shading system according to embodiments;

FIG. 6B illustrates an upper portion of an intelligent umbrella and/or robotic shading system according to embodiments;

FIG. 7 illustrates a method of orienting an intelligent umbrella and/or robotic shading system according to embodiments;

FIG. 8A illustrates a top section of an intelligent umbrella including one or more arms/blades;

FIG. 8B illustrates an upper middle section of an intelligent umbrella including skin assemblies and/or shaft or tube assemblies according to embodiments;

FIG. 8C illustrates a lower middle section of an intelligent umbrella including skin assemblies and/or shaft or tube assemblies according to embodiments;

FIG. 8D illustrates a base section of an intelligent umbrella including skin assemblies and/or shaft or tube assemblies according to embodiments; and

FIG. 8E illustrates a cutaway of a shaft and/or tube assembly of an intelligent umbrella including an actuator and/or motor assembly according to embodiments.

### DETAILED DESCRIPTION OF THE EMBODIMENTS

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

With advances in technology, it has become more typical to employ distributed computing approaches in which portions of a problem, such as signal processing of signal samples, for example, may be allocated among computing devices, including one or more clients and/or one or more servers, via a computing and/or communications network, for example. A network may comprise two or more network devices and/or may couple network devices so that signal communications, such as in the form of signal packets and/or frames (e.g., comprising one or more signal samples), for example, may be exchanged, such as between a server and a client device and/or other types of devices, including between wireless devices coupled via a wireless network, for example.

A network may comprise two or more network and/or computing devices and/or may couple network and/or computing devices so that signal communications, such as in the form of signal packets, for example, may be exchanged, such as between a server and a client device and/or other types of devices, including between wireless devices coupled via a wireless network, for example.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals (e.g., signal samples), such as in memory as physical memory states, and/or may, for example, operate as a server in various embodiments.

Computing devices, mobile computing devices, and/or network devices capable of operating as a server, or otherwise, may include, as examples, rack-mounted servers, desktop computers, laptop computers, set top boxes, tablets, netbooks, smart phones, wearable devices, integrated devices combining two or more features of the foregoing devices, the like or any combination thereof. As mentioned, signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases, database servers, application data servers, proxy servers, and/or portions thereof, as appropriate.

It should be understood that for ease of description a network device may be embodied and/or described in terms of a computing device and/or mobile computing device. However, it should further be understood that this description should in no way be construed that claimed subject matter is limited to one embodiment, such as a computing device or a network device, and, instead, may be embodied as a variety of devices or combinations thereof, including, for example, one or more illustrative examples.

Operations and/or processing, such as in association with networks, such as computing and/or communications networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context. In a context of this application, if signals, instructions, and/or commands are transmitted from one component (e.g., a controller or processor) to another component (or assembly), it is understood that messages, signals, instructions, and/or commands may be transmitted directly to a component, or may pass through a number of other components on a way to a destination component. For example, a signal transmitted from a motor controller or processor to a motor (or other driving assembly) may pass through glue logic, an amplifier, an analog-to-digital converter, a digital-to-analog converter, another controller and/or processor, and/or an interface. Similarly, a signal communicated through a misting system may pass through an air conditioning and/or a heating module, and a signal communicated from any one or a number of sensors to a controller and/or processor may pass through a conditioning module, an analog-to-digital controller, and/or a comparison module, and/or a number of other electrical assemblies and/or components.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

A network may also include for example, past, present and/or future mass storage, such as cloud storage, cloud server farms, and/or other forms of computing and/or device readable media, for example. A network may include a portion of the Internet, one or more local area networks (LANs), one or more wide area networks (WANs), wire-line type connections, one or more personal area networks (PANs), wireless type connections, one or more mesh networks, one or more cellular communication networks, other connections, or any combination thereof. Thus, a network may be worldwide in scope and/or extent.

The Internet and/or a global communications network may refer to a decentralized global network of interoperable networks that comply with the Internet Protocol (IP). It is noted that there are several versions of the Internet Protocol. Here, the term Internet Protocol, IP, and/or similar terms, is intended to refer to any version, now known and/or later developed of the Internet Protocol. The Internet may include local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices and/or computing devices may engage in an HTTP session through an exchange of appropriately compatible and/or compliant signal packets and/or frames. Here, the term Hypertext Transfer Protocol, HTTP, and/or similar terms is intended to refer to any version, now known and/or later developed. It is likewise noted that in various places in this document substitution of the term Internet with the term World Wide Web (‘Web’) may be made without a significant departure in meaning and may, therefore, not be inappropriate in that the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. A content delivery server and/or the Internet and/or the Web, therefore, in this context, may comprise an service that organizes stored content, such as, for example, text, images, video, etc., through the use of hypermedia, for example. A HyperText Markup Language (“HTML”), Cascading Style Sheets (“CSS”) or Extensible Markup Language (“XML”), for example, may be utilized to specify content and/or to specify a format for hypermedia type content, such as in the form of a file and/or an “electronic document,” such as a Web page, for example. HTML and/or XML are merely example languages provided as illustrations and intended to refer to any version, now known and/or developed at another time and claimed subject matter is not intended to be limited to examples provided as illustrations, of course.

Also as used herein, one or more parameters may be descriptive of a collection of signal samples, such as one or more electronic documents, and exist in the form of physical signals and/or physical states, such as memory states. For example, one or more parameters, such as referring to an electronic document comprising an image, may include parameters, such as 1) time of day at which an image was captured, latitude and longitude of an image capture device, such as a camera or where an intelligent umbrella and/or robotic shading system may be located; 2) time and day of when a sensor reading (e.g., humidity, temperature, air quality, UV radiation) was received and/or measurement taken; and/or 3) operating conditions of one or more motors or other components or assemblies in a modular umbrella shading system, intelligent umbrella and/or robotic shading system. Claimed subject matter is intended to embrace meaningful, descriptive parameters in any format, so long as the one or more parameters comprise physical signals and/or states, which may include, as parameter examples, name of the collection of signals and/or states.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In embodiments, a computing device may be installed within or as part of an intelligent umbrella and/or robotic shading system. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, numbers, numerals or the like, and that these are conventional labels. Unless specifically stated otherwise, it is appreciated that throughout this specification discussions utilizing terms such as “processing,” “computing,” “calculating,” “determining” or the like may refer to actions or processes of a specific apparatus, such as a special purpose computer or a similar special purpose electronic computing device (e.g., such as an artificial intelligence computing device). In the context of this specification, therefore, a special purpose computer or a similar special purpose electronic computing device (e.g., a computing device integrated within a robotic shading system and/or intelligent umbrealla) is capable of manipulating or transforming signals (electronic and/or magnetic) in memories (or components thereof), other storage devices, transmission devices sound reproduction devices, and/or display devices.

In an embodiment, a controller and/or a processor typically performs a series of instructions resulting in data manipulation. In an embodiment, a microcontroller or microprocessor may be a compact microcomputer designed to govern the operation of embedded systems in electronic devices, e.g., an Al computing device with a shading element and/or shading structure, an Al device with a shading element, and various other electronic and mechanical devices coupled thereto or installed thereon. Microcontrollers may include processors, microprocessors, and other electronic components. Controller may be a commercially available processor such as an Intel Pentium, Motorola PowerPC, SGI MIPS, Sun UltraSPARC, Ardino, single-board microcomputer, Linux based single board microcomputer, Qualcomm Snapdragon processor, or Hewlett-Packard PA-RISC processor, but may be any type of application-specific and/or specifically designed processor or controller. In an embodiment, a processor and/or controller may be connected to other system elements, including one or more memory devices, by a bus, a mesh network or other mesh components. Usually, a processor or controller, may execute an operating system which may be, for example, a Windows-based operating system (Microsoft), a MAC OS System X operating system (Apple Computer), one of many Linux-based operating system distributions (e.g., an open source operating system) a Solaris operating system (Sun), a portable electronic device operating system (e.g., mobile phone operating systems, iOS, Android, Microsoft Phone, etc.), microcomputer operating systems, single board computer operating systems, and/or a UNIX operating systems. Embodiments are not limited to any particular implementation and/or operating system.

In embodiments, a shading element and/or shading structure may further comprise solar cells and/or solar arrays to generate power for operation of the Al system with shading element. In embodiments, the shading element or shading structure may be a simple shading fabric, or a shading frame and shading fabric. In embodiments, the shading element or shading structure may be an automated and/or intelligent and may respond to commands, instructions and/or signals audibly spoken by a user/operator or generated by a processor upon execution of computer-readable instructions. The shading system, shading structure and/or shading element may be referred to as a parasol, an intelligent umbrella, a robotic shading system, an umbrella, a sun shade, sun screen, sun shelter, awning, sun cover, sun marquee, brolly and other similar names, which may all be utilized interchangeably in this application. These terms may be utilized interchangeably throughout the specification. In embodiments, a shading element or shading structure may be part of an intelligent umbrella and/or robotic shading system.

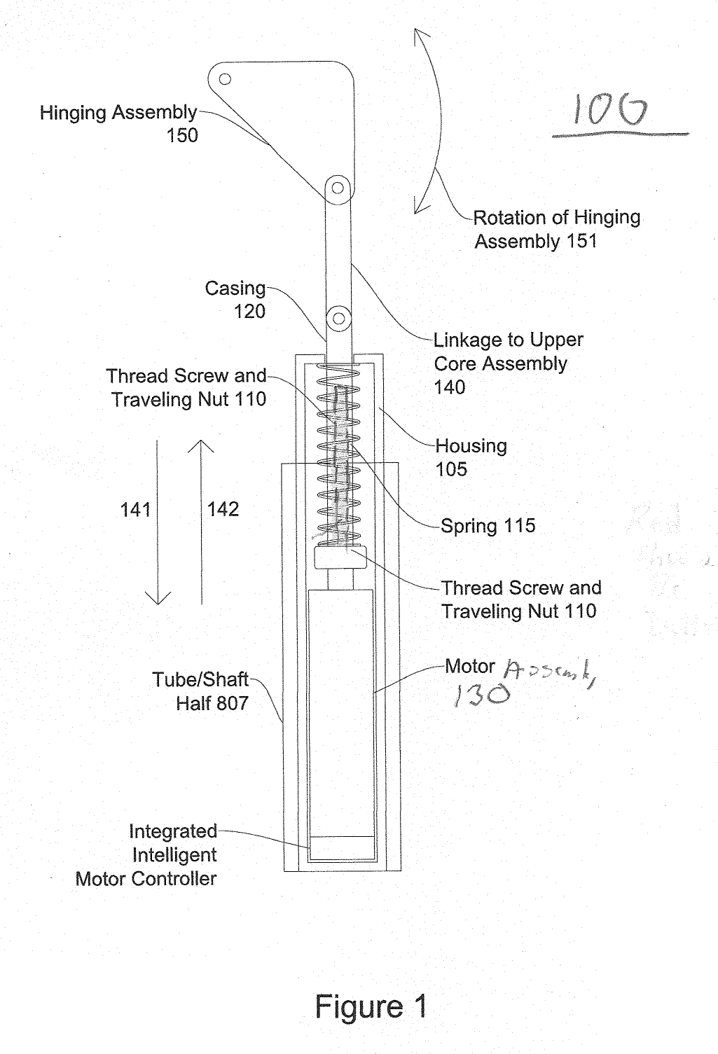

FIG. 1 illustrates an improved actuator assembly according to embodiments. In embodiments, a core of the improved actuators and/or actuator assemblies is an idea of collecting energy driven by gravity and using this energy to assist when performing an action against gravity. In embodiments, for example, during an umbrella, parasol or shading system lowering operation, gravity may help to compress an internal spring which generates energy as an internal spring is compressing. In embodiments, for example, during an umbrella, parasol or shading system lifting operation, this energy (e.g., stored energy) may be released back which may assist a motor (and a motor assembly) so less electrical power may be utilized in raising an umbrella, parasol or shading system (e.g., an center support assembly) against a gravitational force.

In embodiments, one or more motors may comprise or include encoders and/or limit switches, which provide positional data to smart motor drivers or controllers that may be placed within the motor housing and/or the umbrella, parasol or shading system housing. In embodiments, the improved actuator can reduce the load on a motor control unit or motion controller because less current is utilized to move the umbrella. This is especially true in moving an upper assembly (which has a significant weight) with respect to a lower assembly utilizing for example a hinging assembly. Normally that elevation movement causes not only current strain but also torque on the hinging assembly, motor assembly and/or actuator assembly. The spring wrapped around the actuator assembly is used to counteract these forces and reduce the strains placed on the system. In embodiments, wrapping such a spring about an actuator may also be utilized in other situations using actuators such as using an actuator to expand and retract arms (via arm support assemblies) or to expand and retracts a support frame for an umbrella, parasol, or shading device. In addition, this may be utilized in umbrellas, parasols or shading devices using actuators for pulley ropes, cables and/or telescoping.

In embodiments, an improved actuator may be utilized in an intelligent umbrella, robotic umbrella and/or robotic shading system. In embodiments, an actuator 100 comprise a threaded screw with traveling nut 110, a spring or tension spring 115, and/or a casing or an actuator casing 120. In embodiments, an actuator may sit, rest or be positioned in a channel (not shown) of a housing or housing assembly 105. In embodiments, a housing or housing assembly 105 may be comprised of a lightweight aluminum material. In embodiments, weight may be reduced overall in an intelligent umbrella, parasol or shading systems due to use of lightweight metal in housing assemblies 105 and/or other structural components.

In embodiment, a threaded screw with traveling nut 110 may comprise a nut coupled, connected, fastened and/or adhered to a threaded screw. In embodiments, a nut may be comprised or made of a nylon, plastic, metal or composite material. In embodiments, a threaded screw or rod may be comprised or made of a nylon, plastic, metal or composite material in order for the screw or rod to be durable and/or lightweight. In embodiments, an actuator 100 may be coupled and/or connected to a motor assembly 130. In embodiments, a motor shaft of a motor assembly 130 may be coupled and/or connected to a bottom section of an actuator 100. In embodiments, a motor (e.g., motor shaft) may be attached, coupled or connected to one end of the threaded screw either directly or indirectly (in some embodiments for example indirectly through a gear box). In embodiments, a motor in a motor assembly 130 may spin, which spins a motor shaft, which causes a threaded screw and the traveling nut 110 to rotate. In embodiments, a traveling nut and screw 110 may be restrained from spinning so a traveling nut may travel and/or move up and down a threaded screw and traveling nut 110.

In embodiments, a threaded screw and traveling nut 110 may be coupled, connected, fastened and/or adhered to a casing, housing or actuator casing 120. In embodiments, a threaded screw and traveling nut 110 may be fastened, adhered, coupled and/or connected to an interior or interior surface of an actuator casing 120. In embodiments, because a traveling nut up travels up and down a threaded screw, the actual casing 120 may be attached to the traveling nut may move up and down in response to a motor assembly operating and a shaft spinning. In embodiments, a linkage or housing 140 may be attached, connected, coupled and/or adhered to an end (e.g., upper end or second end) of a casing 120 (or to a threaded screw of the threaded screw and traveling nut 110). In such embodiments, a linkage or housing 140 may move based, at least in part, upon movements of the casing 120 and/or threaded screw and travelling nut). In embodiments, a linkage or housing 140 may move in an up and down direction (e.g., vertical direction) or in other directions depending on hinging or gearing assemblies included in a linkage assembly and/or housing 140. In embodiments, a linkage assembly or housing 140 may be coupled, connected, attached or fastened to a hinging assembly 150. In embodiments, movements caused by a motor assembly 130 may cause movement of the threaded screw and traveling nut 110 and this may cause movements of an actuator casing 120 and a linkage assembly 140. In addition, this may result in movement and/or rotation of a hinging assembly 150. In embodiments, a hinging assembly 150 may move and/or rotate in a clockwise and/or counterclockwise direction, as is illustrated by reference number 151 and associated arrow.

In embodiments, a spring, tension spring and/or compression spring 115 may be positioned and/or placed around a casing or housing 120, as is illustrated in FIG. 1. This is a unique use in an umbrella, parasol or shading system that helps reduce electrical requirements of a motor assembly 130. In embodiments, for example, as a casing 120 moves up (e.g., in an upwards vertical direction 142) a spring, tension spring and/or compression spring 115 may stretch from an original position. In embodiments, a spring 115 may expand in an upward direction. In embodiments, as a spring 115 expands, potential energy or energy is stored in the spring 115. In embodiments, a casing 120 may move to a stopping position. In embodiments, a casing 120 may move down (e.g., in a vertical direction as illustrated by reference number 141 in FIG. 1) in a downward vertical direction because a motor shaft of a motor assembly 130 may spin in an opposite direction which may cause a traveling nut 110 to rotate in an opposite direction and traveling nut 110 to move in a downward vertical direction. In embodiments, especially if gravity is pulling down whatever is connected to the actuator assembly (e.g., a linking assembly or housing 140, or a hinging assembly 150) a torque may increased on the motor assembly 130, especially if a hinging assembly 150 is attempting to pull itself back up to a vertical position in line with a linkage assembly 140. In such embodiments, a spring 115 may release energy and/or potential energy when it moves from a stretched position back to its original position (e.g., when the casing 120 (and traveling nut 110) move in a downward direction). In embodiments, energy released from the spring 115 may reduce the torque requirements on the motor of the motor assembly 130, which is needed to rotate the hinging assembly 150 back to its original position.

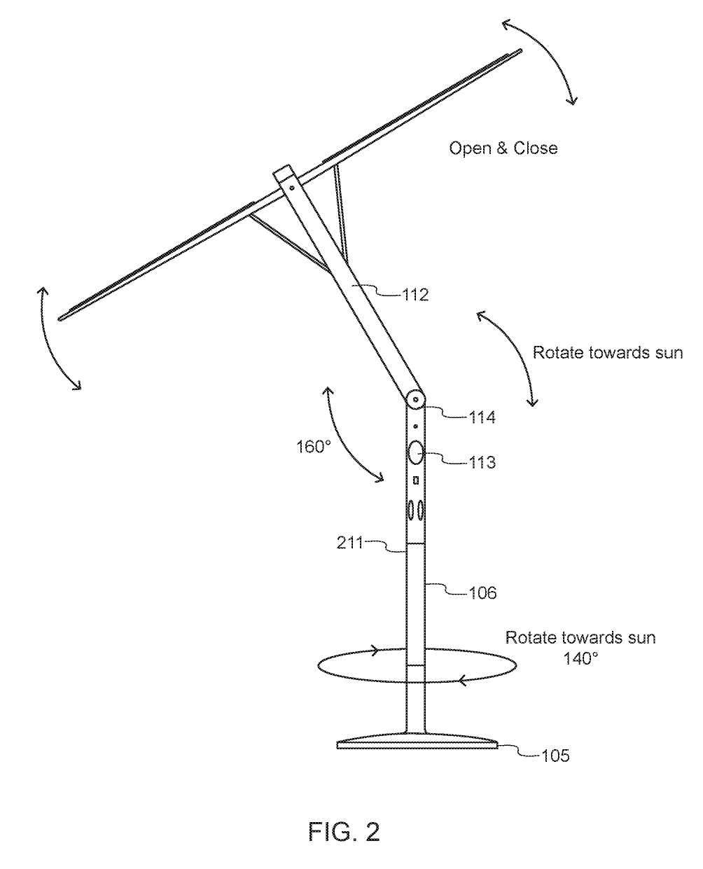

FIG. 2 illustrates an umbrella utilizing a hinging assembly for performing elevation rotation according to embodiments. As can be seen in FIG. 2, an upper part 112 of a middle assembly of an intelligent umbrella rotates counterclockwise about a hinging assembly 114 with respect to a lower part 113 of a middle or core assembly. This rotation is illustrated by reference number 160 in FIG. 2. As is seen in FIG. 2, the placement of the middle assembly rotated about 20 to 30 degrees counterclockwise from straight vertical (or a 12 o'clock position) along with gravity creates a torque and/or torque requirement on the motor 130 assembly (FIG. 1) to bring the upper part of the middle assembly back to a vertical position. In embodiments, an actuator assembly discussed below addresses this problem by reducing the torque or torque requirements on the motor assembly in the lower part or portion of the middle assembly of the umbrella.

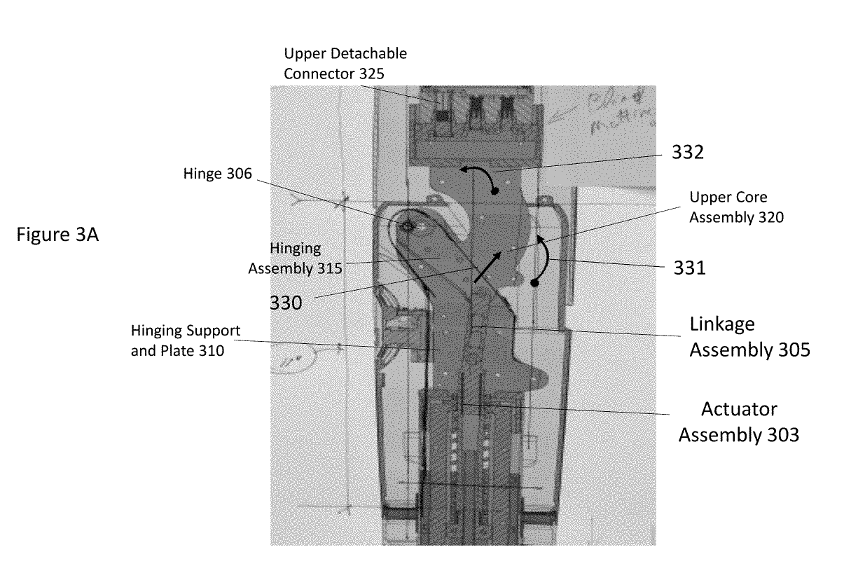

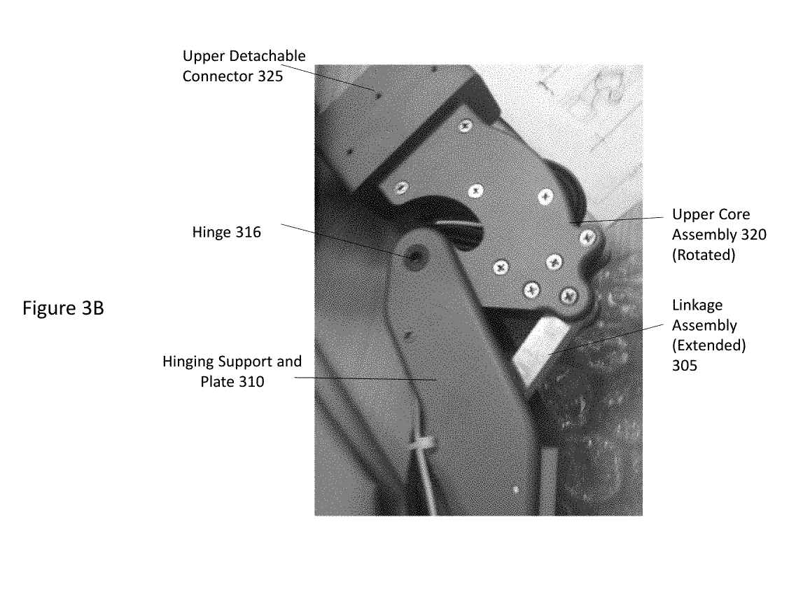

FIG. 3A illustrates an actuator and associated structures in a middle portion of an intelligent umbrella or parasol according to embodiments. FIG. 3A illustrates a middle portion of an intelligent umbrella 300 which rotates about a hinging assembly 315 utilizing an actuator or actuator assembly 303 (such as an actuator assembly described with respect to FIG. 1). In embodiments, an actuator 303 may be coupled, fastened, or connected to a linkage assembly 305. In embodiments, a linkage assembly 305 may be connected to an end of a hinging assembly 315 and another end of a hinging assembly 315 may be connected, coupled and/or fastened to a hinge 306. In addition, in embodiments, a hinging assembly 315 may be connected, coupled and/or fastened to a hinging support or plate 310. In embodiments, a hinging assembly 315 may be coupled to a portion of an upper core assembly 320 (e.g., a rotatable portion of upper core assembly). In embodiments, a portion of an upper core assembly 320 may comprise an upper detachable connector 325. In embodiments, when a motor (not shown) is engaged and spins and/or rotates, an actuator or actuator assembly 303 may move in a vertical direction (e.g., in an upwards direction). In embodiments, upward motion of an actuator assembly 303 may cause a linkage assembly 305 to move upward in a vertical direction. In embodiments, a linkage assembly 305 moving vertically may cause one end of a hinging assembly 315 to move in a direction indicated by reference number 330 (which is a vertical upward direction with an angular component to the right). In embodiments, movement of the one end of a hinging assembly 315 in a vertical direction causes a portion of an upper core assembly 320 to rotate in a circular direction (e.g., in FIG. 3A this is a counterclockwise direction as illustrated by reference numbers 331 and 332). In embodiments, this may represent a rotation caused by an elevation motor in an intelligent umbrella as shown in FIG. 2. In embodiments, a portion of a core assembly 320 may rotate between 0 to 45 degrees of with respect to 90 degrees vertical (which is represented by reference number 333 in FIG. 3A).

FIG. 3B illustrates movement of a portion of an upper core assembly after a linkage assembly has pushed a hinging assembly (not shown in FIG. 3B) to an extended position according to embodiments. In embodiments, a hinging assembly (and an attached portion of an upper core assembly 320) rotates with respect to a hinging support plate 310 via a hinge 316. As is shown in FIG. 3B, the connector (upper detachable connector 325) is at approximately a 45 degree angle with respect to vertical and/or horizontal as compared to a position of the upper detachable connector 325 in FIG. 3A.

In embodiments, as shown by reference number 160 in FIG. 2, an upper part of a core assembly may rotate about a hinging assembly 161 (which is similar to an upper core assembly 320 rotating about a hinging assembly (and hinge 316 in FIGS. 3A and 3B). In both cases, if using a new actuator is described in FIG. 1, a large amount of torque is placed on a motor in order to move an intelligent umbrella, parasol or shading system from a rotated, tilted and/or extended position, as illustrated in FIGS. 1 and 2, back to a position where the upper part of a core assembly (and expansion assembly) is in a vertical line (e.g., an original position) with a base assembly and a lower part of a core assembly. This is due to gravity pulling on an upper part of a core assembly and a larger force is required (and thus larger torque) is required to move the upper part of a core assembly. In embodiments, as discussed above, an actuator assembly 100 and specifically a spring or compression spring 115 on an actuator (which is extended when an upper part of a core assembly 320 rotates about a hinging assembly and energy is retained in the compressed spring 115). In embodiments, when an upper part of a core assembly 320 rotates and/or moves back to an original position (as shown in FIG. 3A) with respect to a linkage assembly 305 and hinging support and plate 310, a large amount of torque is required by a motor. However, if a compression spring 115 is utilized in an actuator assembly 303 (e.g., positioned around and/or connected to an outside surface of an actuator casing), a compression spring 115 returning to an original position (e.g., non-extended position) may release energy which assists in returning an upper part of a core assembly 320 to an original position (e.g., vertical position) and therefore reduces torque placed and/or required by the motor in an intelligent umbrella.

In embodiments, an intelligent umbrella and/or robotic shading system may have two detachable connections, with each connection having a pair of detachable connectors. In embodiments, a base assembly may be detachable from a middle or core assembly. In embodiments, a lower portion of a core assembly may be detachable from an upper portion of a core assembly and also an arm deployment and/or expansion assembly. In embodiments, this is advantageous because for example, an umbrella may need more or less arms in an arm deployment and/or expansion assembly and the upper portion of the core assembly and/or arm deployment and/or expansion assembly may be changed or swapped out. In embodiments, an intelligent umbrella and/or robotic shading system may have three detachable connections, utilizing a pair of detachable connectors at each connection. This makes it easier to swap out the arm deployment and/or expansion assembly. In embodiments, another advantage is that it is easier to replace a standard base assembly with a base assembly designed for sand or a base assembly designed to burrow or grip into a surface. In other words, different base assemblies may be swapped out and/or replaced. Further, by having detachable portions where an upper core assembly and/or an arm deployment and/or expansion assembly may be swapped out or replaced, an integrated computing device may be upgraded to a new computing device and/or motor controllers and/or motors may also be replaced with reside in the upper portion of a core assembly. In embodiments, a sensor assembly may be detachable from an upper portion of an intelligent umbrella and/or robotic shading system.

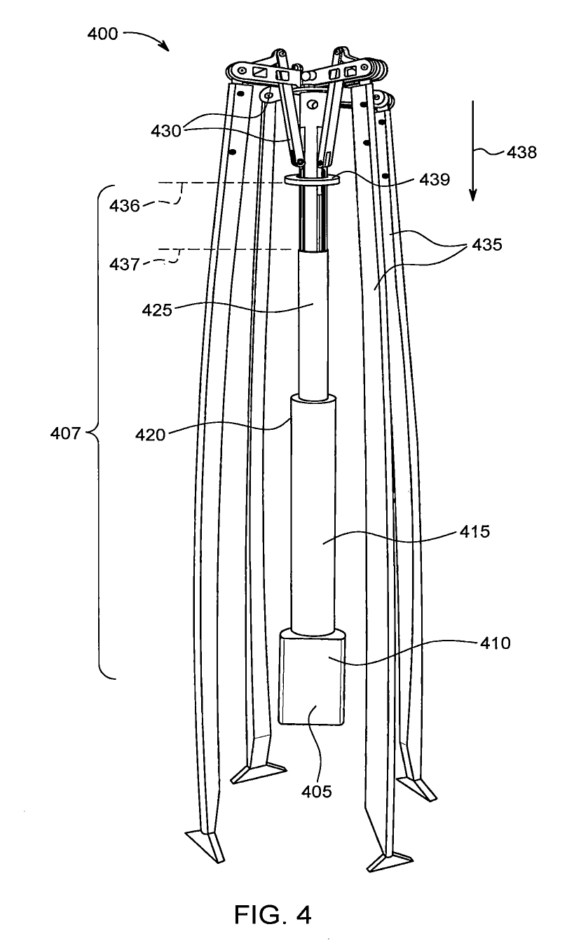

FIG. 4 illustrates an upper portion of an intelligent umbrella or robotic shading system according to embodiments. In embodiments, an upper detachable portion of an umbrella 400 may comprise an upper connection assembly 405, a smart electronics assembly or brain box assembly 410, a main motor circuit assembly 415, a motor assembly 420, an actuator assembly 425, one or more arms or blades 435, and an arm linking or support assembly 430. In embodiments, an upper connection assembly 405 may connect and/or snap on to an upper connection assembly for the core assembly 325 in FIGS. 3A and 3B. In embodiments, a shaft 407 may house a smart box assembly 410, a main motor board 415, a motor assembly 420, and/or an actuator assembly 425. In embodiments, a shaft or tube 407 may be manufactured via an extrusion process of a lightweight metal. In embodiments, a shaft or tube 407 may have tapered sections of smaller diameters. For example, FIG. 4 illustrates a shaft or tube having three tapered sections although more or less extrusions may be present. In embodiments, a smart box assembly or brain box assembly 410 may comprise one or more integrated computing devices (e.g., single board computer devices or Linux-based computer devices) and/or one or more wireless transceivers as well as other low-power consumption devices). In embodiments, a smart box assembly or brain box assembly 410 minimizes use of power for integrated devices and separates these components (single board computing devices and/or wireless transceivers) from other higher power components and power (e.g., voltage and/or current) surges and/or demands. In embodiments, a smart box assembly or brain box assembly 410 may be comprised of a lightweight plastic, nylon and/or composite material.

In embodiments, a main motor board and/or circuit 415 may comprise a motor controller. In embodiments, a motor controller may receive signals, messages, commands from a processor/controller (e.g., in a single board computer) instructing a motor assembly 420 to be activated and/or deactivated. In embodiments, a main motor board and/or circuit 415 may be electrically coupled and/or connected via wires and/or cables to a motor assembly 420. In embodiments, upon receiving command, instructions, messages and/or signals from a main motor board/circuitry 415, a motor may be turned on and/or off and may cause an output shaft to rotate in a clockwise and/or a counterclockwise direction. In embodiments, an output shaft of a motor assembly 420 may be connected, coupled and/or attached to an actuator assembly 425. In embodiments, an actuator assembly 425 operates in a manner as described as described in FIGS. 1, 2, 3A and 3B. In embodiments, an actuator assembly 425 may be in an extended position and/or first position 436 when arms and/or blades 435 are down in a closed position, as illustrated in FIG. 4. In embodiments, when an actuator assembly 425 is activated or moved by a motor assembly 420, an actuator assembly 425 (e.g., a casing in an actuator assembly) may travel or move in a vertical downward direction, as is illustrated in reference number 438. In embodiments, an actuator may move to a second position, as illustrated by reference number 437. In embodiments, movement of actuator assembly 425 in a downward direction causes movement of ring 439 in a downward direction and a linking assembly of an arm linking and support assembly 430 in a downward vertical direction. In embodiments, this in turn causes one or more arms 435 to move from a closed (or at rest position) to an open and/or extended position.

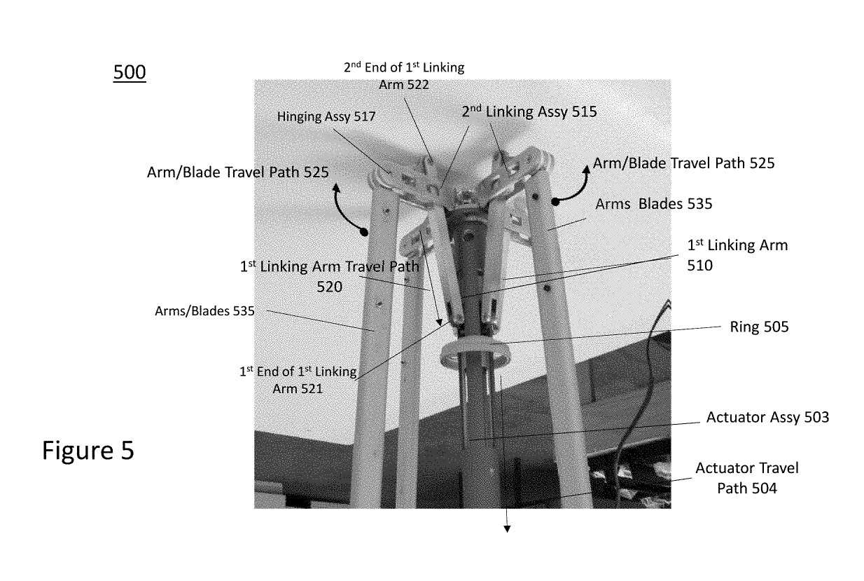

FIG. 5 illustrates operation of an arm linking and support assembly according to embodiments. In embodiments an actuator assembly 503 may be connected to an arm linking and support assembly 500 which may be connected to one or more arms and/or blades 535. In embodiments, an arm linking and support assembly 430 may comprise a ring 505, one or more first (1^{st}) linking arms or assemblies 510, and one or more second (2^{nd}) linking assemblies 515. In embodiments, one or more second (2^{nd}) linking assemblies 515 may be connected, coupled, fastened and/or attached to one or more arms and/or blades 535. In embodiments, an actuator assembly 503 (e.g., a casing of an actuator assembly) may move in a vertical downward direction along a path as illustrated by reference number 504. In embodiments, an actuator assembly 503 may be coupled, connected, fastened, or adhered, directly or indirectly to a ring 505 and/or a first linking arm or assembly 510. In response to (or because of a downward movement of an actuator assembly 503), a ring 505 and/or a first linking arm or assembly 510 may move in a downward direction (e.g., a downward vertical direction), as illustrated by reference number 520 (in FIG. 5). Although the following is described with respect to one first linking assembly 510, a second linking assembly 515 and an arm or blade 535, the operation occurs with respect to each combination of first linking assembly 510, second linking assembly 515, and/or arms or blades 535 present in an intelligent umbrella and/or robotic shading system. For example, in embodiments, an intelligent umbrella or robotic shading system may comprise two combinations of first linking assemblies, second linking assemblies and/or arms or blades; four combinations or first linking assemblies, second linking assemblies and/or arms or blades (as illustrated in FIG. 5) and/or any other integer number of first linking assemblies, second linking assemblies and/or arms or blades. In embodiments, a first end 521 of a first linking arm or assembly 510 is connected to a ring 505 and/or an actuator assembly. In embodiments, a second end 522 of a first linking arm or assembly 510 may be coupled, connected and/or fastened to second linking assembly 515. In embodiments, a second linking assembly 515 may comprise a gearing assembly (not shown) and/or a hinging assembly 517. In embodiments, a second end 522 of a first linking arm or assembly 510 may be coupled, connected and/or fastened to a gearing assembly in a second linking assembly 515. Movement of a 2^{nd} end 522 of a first linking arm or assembly 520 in a downward vertical directional (similar to travel path 520) engages a gearing assembly. In embodiment, a gearing assembly may be coupled, connected and/or fastened, directly or indirectly, to a hinging assembly 517. In embodiments, engagement of a gearing assembly by a second end 522 of a first linking assembly 510 may result in or cause gears to spin and/or rotate, which causes rotation of a hinging assembly 517. In embodiments, a hinging assembly 517 may be coupled, connected, attached and/or fastened to an arm and/or blade 535. In embodiments, rotation of a hinging assembly 517 may cause an arm or blade 535 to move from an at-rest position or closed position to an open or extended position. In embodiments, a direction of rotation of a hinging assembly 517 and rotation of an arm or blade to an open position is illustrated by reference number 525 in FIG. 5. In embodiments, the operation discussed above may be performed in an opposition direction in order to retract or pull back the arms and/or blades from an open position to a closed position. As discussed previously, retracting and/or pulling back of arms and/or blades may require a large amount of torque from a motor and the actuator described in the FIGS. 1 and 2 may reduce the amount of torque required by its use of a spring and/or compression spring around a casing of an actuator assembly 503. In embodiments, in an at-rest position, each combination of a first linking assembly 510, a second linking assembly 515 and/or an arm or blade 535 may form a U-shape. In embodiments, a first linking assembly 510 may be connected to a second linking assembly 515 at an angle between 60 to 120 degree angle when at rest. In embodiments, a second linking assembly 515 may be connected to an arm or blade 535 at approximately a 90 degree angle when an arm or blade 535 is in a closed and/or at rest position. In embodiments, a second linking assembly 515 may be connected to an arm or blade 535 at approximately a 180 degree angle via a hinging assembly 517. In this embodiment, an arm or blade 535 may appear to be an extension of second linking assembly 515. In embodiments, a second linking assembly 515 may comprise a first hinging assembly (connected to an end of the first linking assembly 510) and a second hinging assembly 517. In embodiments, when a first linking assembly 510 moves downward to an open position for the intelligent umbrella in response to actuator movement, a first hinging assembly of the second linking assembly 515 may be pulled by a first linking assembly 510 in a mainly vertical direction, which may cause a gearing assembly that is attached to a hinging assembly (and/or a chain assembly) to move in either a clockwise and/or counterclockwise direction. In embodiments, the movement of the gearing assembly (and/or chain assembly) in a clockwise and/or counterclockwise may cause the second hinging assembly 517 of the second linking assembly 515 to rotate and move the arm or blade 535 to an open position. In embodiments, this expansion and retraction operation (or opening and closing operation) may be reversed to move the arms to an original position.

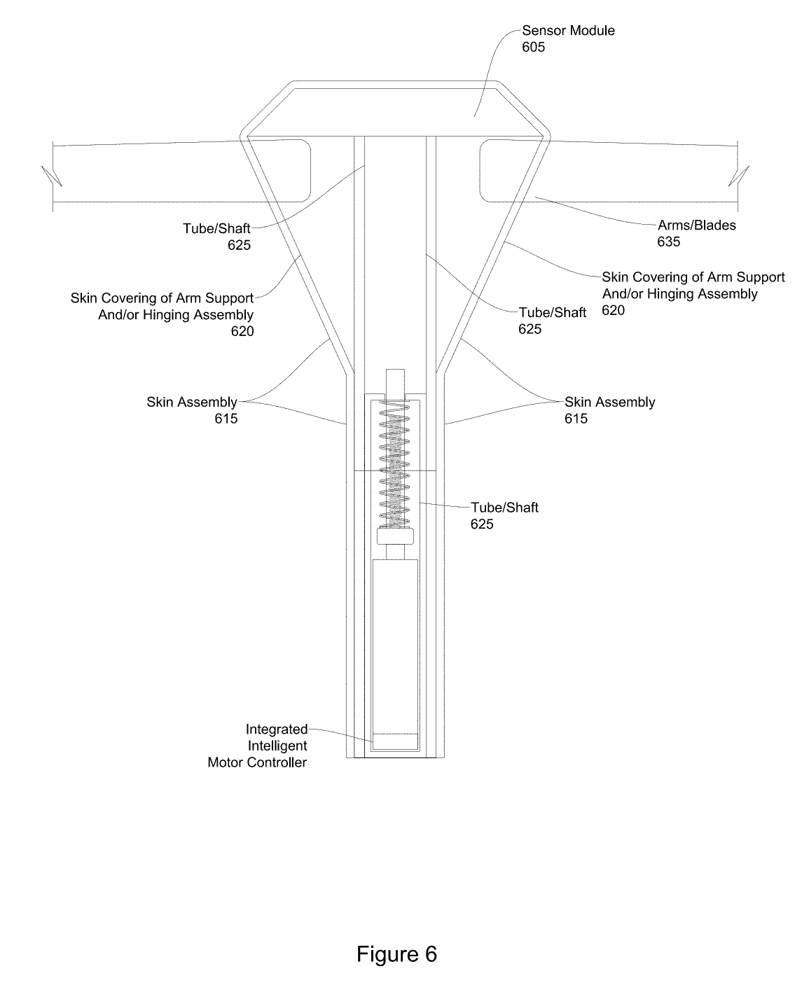

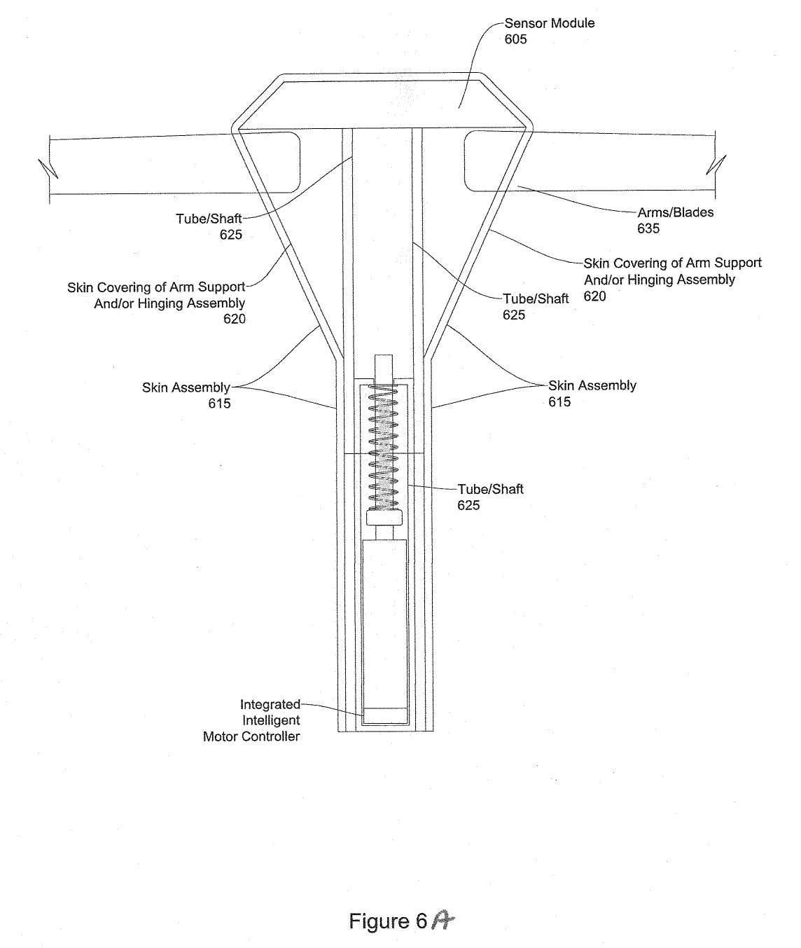

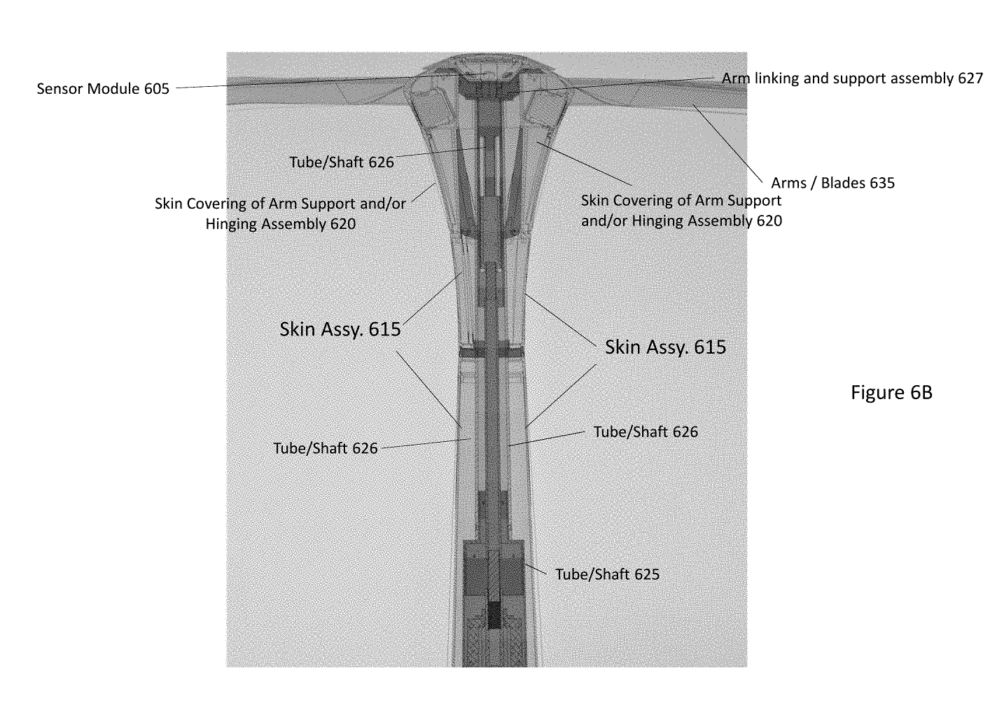

FIG. 6 illustrates an upper portion of an intelligent umbrella or robotic shading system according to embodiments. FIG. 6A illustrates an upper portion of an intelligent umbrella and/or robotic shading system according to embodiments. FIG. 6B illustrates an upper portion of an intelligent umbrella and/or robotic shading system according to embodiments. In embodiments, an upper portion may comprise lightweight materials in order to allow an intelligent umbrella and/or robotic shading system to be under 75 pounds and classified as portable. This may be accomplished by utilizing lightweight materials such as lightweight metals for tube and shafts, blades, and base portions of the intelligent umbrellas. In many cases, these are interior portions of an intelligent umbrella and/or robotic shading systems and may not be visible to a user (except in the case of arms and/or blades). With respect to an upper portion of an intelligent umbrella and/or robotic shading system, a tube and/or shaft 625 made of a lightweight metal may run through an interior middle of an upper portion of an intelligent umbrella. In embodiments, a tube and/or shaft 625 in a bottom section of an upper portion of an intelligent umbrella, parasol or shading system may have a tube and/or shaft 625 with a larger diameter. In embodiments, a larger diameter may be preferable to house a number of components such as a single board computing device and/or wireless transceivers and/or a motor control circuitry and/or a motor assembly. In embodiments, a tube and/or shaft 626 in a middle and higher section of an upper portion of an intelligent umbrella may have a smaller diameter as compared to a tube and/or shaft 625 of bottom section. In embodiments, a tube and/or shaft 625 (or an actuator assembly) may be connected to an arm linking and/or expansion assembly 627, which may in turn be connected, coupled and/or attached to one or more arms and/or blades 635 in order to open and/or close arms and/or blades 635. In embodiments, an arm linking and/or expansion assembly 627 may be made of a plastic material, a nylon material, a lightweight metal, and/or a composite material, or combination thereof. In embodiments, a sensor module 605 may be coupled, connected and/or attached to a tube and/or shaft 626, an arm linking and/or expansion assembly 627 and/or one or more arms or blades 635. In embodiments, a sensor module 605 may comprise one or more environmental sensors, a GPS, a digital compass, and/or a digital barometer. In embodiments, a sensor module 605 may be detachably connected to a tube and/or shaft 626, an arm linking and/or expansion assembly 627 and/or one or more arms or blades 635. In embodiments, this provides an advantage of easy replacement if one or more sensors are failing or if one or more additional sensors (e.g., carbon monoxide sensors) may need to be included in a sensor module 605. In embodiments, a skin assembly 615 may be attached to a tube and/or shaft 625 or 626 to provide protection for a tube or shaft 625 or 626 (and components attached thereto and integrated within a tube or shaft) from environmental conditions such as rain or humidity. In embodiments, a skin assembly 615 may be comprised of a plastic material, a fiberglass material, a composite material, or a combination thereof. In embodiments, an arm support linking assembly 627 and associated mechanisms and components may be out in public view which may create a safety hazard by having people hit their heads on metal spokes and bands. In embodiments, an intelligent umbrella and/or robotic shading system may have a skin covering for an arm support and/or expansion assembly 620 which provides protection for the support linking assembly 627 from environmental conditions and/or safety issues. In embodiments, it is also more aesthetically pleasing to umbrella and/or shading system owners. In embodiments, a skin assembly for an arm support assembly 620 may include openings or portions to allow arms to be extended and/or retracted.

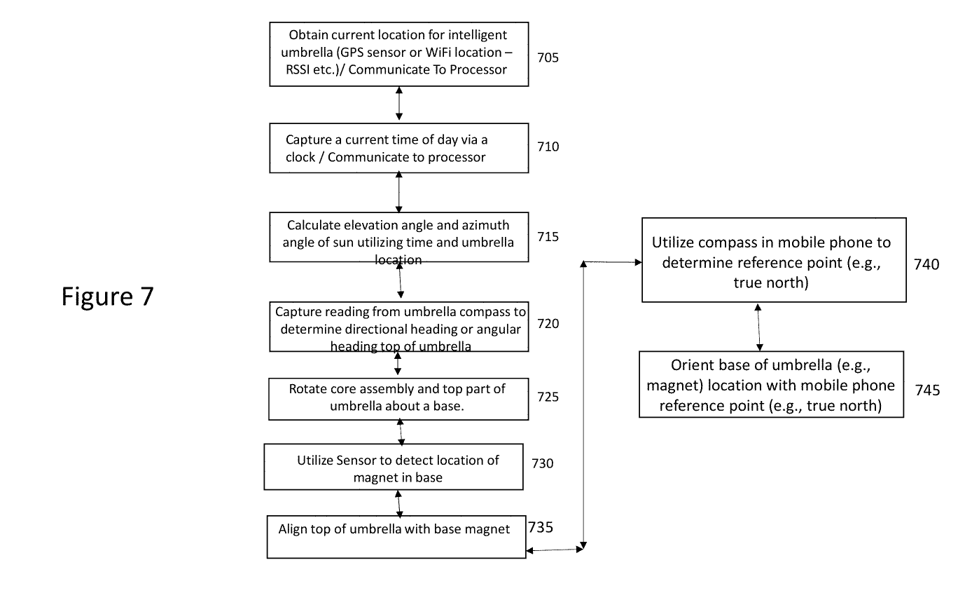

FIG. 7 illustrates a method of orienting an intelligent umbrella and/or robotic shading system according to embodiments. In embodiments, an intelligent umbrella and/or robotic shading system comprises a global location sensor (e.g., located in a sensor module and/or other top portion of an intelligent umbrella or shading robotic shading system). In embodiments, an intelligent umbrella and/or robotic shading system comprises a compass or digital compass. In embodiments, a compass (e.g., digital compass) may be located in a sensor module or in a top portion of an intelligent umbrella or robotic shading system. In embodiments, a base assembly of an intelligent umbrella assembly may comprise a magnet (or magnetic assembly). In embodiments, an intelligent umbrella assembly may comprise a sensor for detecting a presence of a magnetic field generated by the magnet in the base assembly. In embodiments, a magnet may be located in a bottom portion of a core assembly. In embodiments, an intelligent umbrella and/or robotic shading system may comprise one or more processors, one or more memory modules and computer-readable instructions stored in the one or more memory modules that may be executed by the one or more processors.

In embodiments, computer-readable instructions executable by one or more processors may communicate with a global positioning receiver to obtain 705 current location measurements for an intelligent umbrella/robotic shading system. In embodiments, a global positioning receiver may be a global positioning system (GPS) receiver. In embodiments, other global positioning systems and/or networks may be utilized to calculate and/or determine location of an intelligent umbrella/robotic shading system and location receivers in the intelligent umbrella/robotic shading system may have to be compatible and have to receive signals and/or commands from the corresponding global location networks. In embodiments, other global positioning systems and/or networks may comprise the Russian Global Navigation Satellite System (GLONASS), the European Union Galileo positioning system, China's BeiDou Navigation Satellite System, India's NAVIC System and Japan's Quasi-Zenith Satellite System. Thus, in embodiments, location receivers in intelligent umbrella/robotic shading system may need to match and be able to receive signals and/or transmissions from the above-listed location and/or satellite systems. In embodiments, if GPS or other global location determination is not available, an intelligent umbrella system may utilize WiFi location determination to determine locations coordinates for itself that can be utilized in further calculations. For example, WiFi location determination may utilized methods such as RSSI and lateralization based localization; fingerprinting based localization and/or time of flight based localization. In embodiments, for example, RSSI localization techniques are based on measuring signal strength from an intelligent umbrella to several different access points, and then combining this information with a propagation model to determine the distance between the intelligent umbrella and the access points. Trilateration (sometimes called multi-lateralization) techniques can be used to calculate the estimated intelligent umbrella/robotic shading system position relative to the known position of access points. In embodiments, traditional fingerprinting localization techniques are also RSSI-based, but it simply relies on the recording of a signal strength from several access points in range and storing this information in a database along with the known coordinates of the client device in an offline phase. This information can be deterministic or probabilistic. During the online tracking phase, the current RSSI vector at an unknown location is compared to those stored in the fingerprint and the closest match is returned as the estimated user location. In embodiments, a time of flight localization approach utilizes timestamps provided by wireless interfaces to calculate the time of flight (ToF) of signals and then use this information to estimate the distance and relative position of one intelligent umbrella with respect to access points.

In embodiments, computer-readable instructions executable by one or more processors may communicate with a clock in an intelligent umbrella and may retrieve 710 a time and/or from the clock in the intelligent umbrella. In embodiments, a time and/or date may be retrieved from a clock in a mobile communication device coupled and/or connected to the intelligent umbrella.

In embodiments, computer-readable instructions executable by one or more processors may calculate 715 an elevation angle and azimuth position of a light source (e.g., the sun) with respect to an intelligent umbrella and/or robotic shading system, based at least in part, on the time and date and the geographical location received from the global location receiver (or determined via WiFi localization methods).

In embodiments, it is now important to identify and/or determine an orientation of an intelligent umbrella and/or robotic shading system in order to position a shading fabric in the best position to provide shade to a user. In embodiments, different portions of an intelligent umbrella (e.g., a top section of an intelligent umbrella and/or a base assembly of an intelligent umbrella) may have different orientations. In embodiments, a top portion of an intelligent umbrella may have a sensor module including a digital compass and/or a compass. In embodiments, computer-readable instructions executable by one or more processors may communicate with a digital compass and retrieve 720 a directional and/or angular heading of a top portion the intelligent umbrella from the digital compass. In embodiments, readings from a digital compass and/or compass may be notoriously unreliable and/or inaccurate. Plus, while an angular orientation has been determined for a top portion or upper portion of an umbrella, because the upper portion and/or middle portion of an intelligent umbrella/robotic shading system may rotate, a base assembly may have a different orientation (e.g., with respect to a light source).

In embodiments, in order to determine an angular orientation of a base assembly, an upper portion of an intelligent umbrella (e.g., a core assembly and/or an arm support and expansion assembly) may rotate 725 about a base assembly. In embodiments, a base assembly may comprise a magnet installed therein. In embodiments, an upper portion of an intelligent umbrella may comprise a sensor (e.g., a hall-effect sensor) that may identify 730 where a magnet is (e.g., a location of a magnet) in a base assembly. In other words, a hall-effect sensor may generate a reading and identify when an upper portion of an intelligent umbrella has the same heading and/or orientation as the base assembly, because the hall-effect sensor is on top of a magnet or at a same angular orientation as a magnet (which is installed in a base assembly). In embodiments, a top section of an umbrella may be aligned 735 with a base magnet. In embodiments, this may occur automatically or this may require manual movement of portions of an intelligent umbrella and/or robotic shading system. However, while the base assembly and/or the remainder of the intelligent umbrella now have a same or similar angular orientation, there is still no guarantee that an intelligent umbrella understands exactly where a reference direction is located (e.g., where a true north vector is located). As mentioned before, a digital compass in an intelligent umbrella may be unreliable. In embodiments, a user may utilize a compass of a mobile computing device to identify 740 which angular displacement is a reference direction (e.g., true north). In embodiments, a mobile phone may be placed on an intelligent umbrella, e.g., on a base assembly to identify true north. In embodiments, a user and/or operator may orient a base of an umbrella (e.g., a magnet in a base of an umbrella) to be aligned and/or oriented 745 with a compass reading/heading of a mobile communication device. In embodiments, a compass of a mobile communications device is utilized as a backup to a compass in an intelligent umbrella. In embodiments, if an umbrella is physically moved to another location, the calibration and/or adjustment process as described in FIG. 7 may need to be reinitiated in order to align an intelligent umbrella correctly.

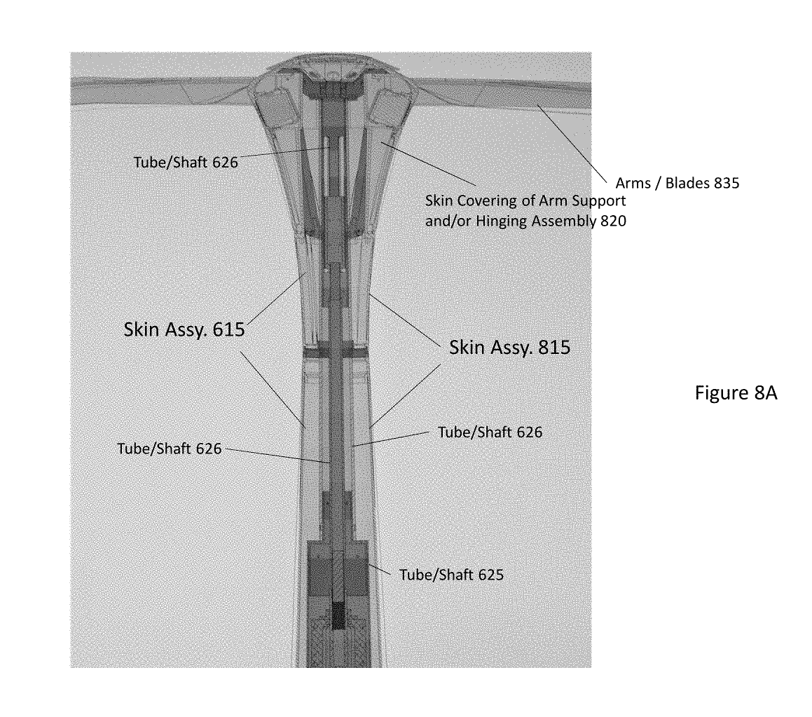

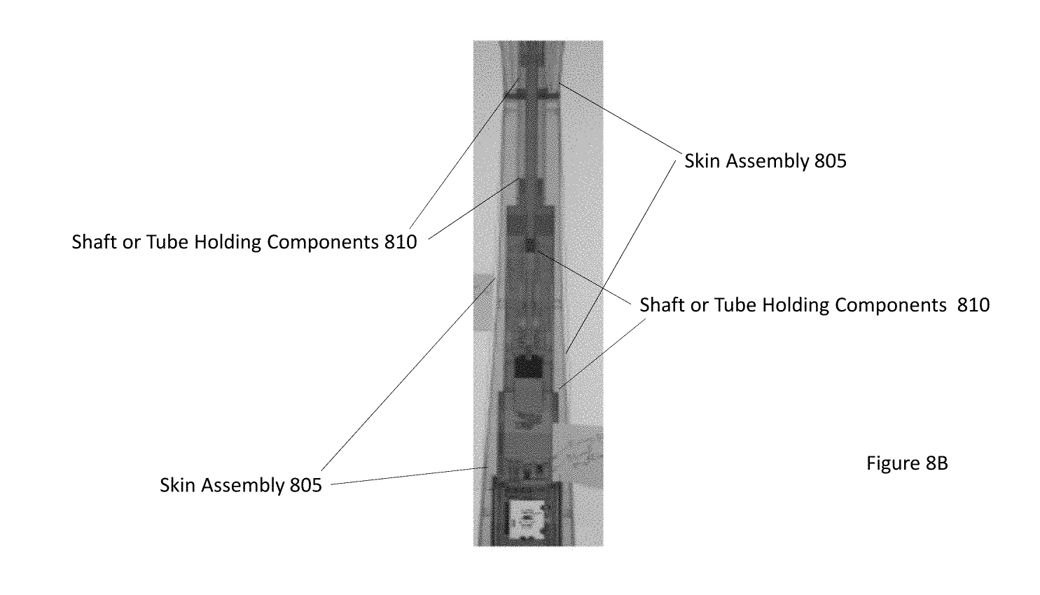

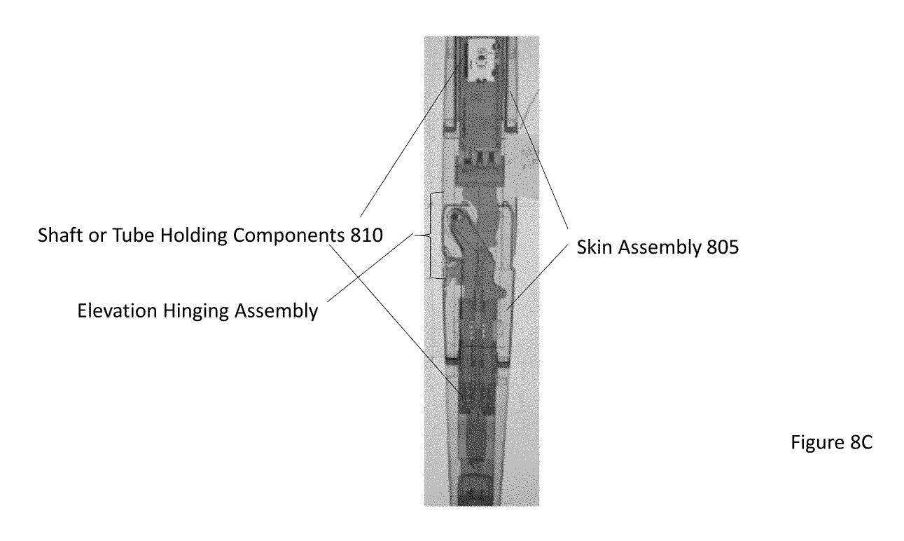

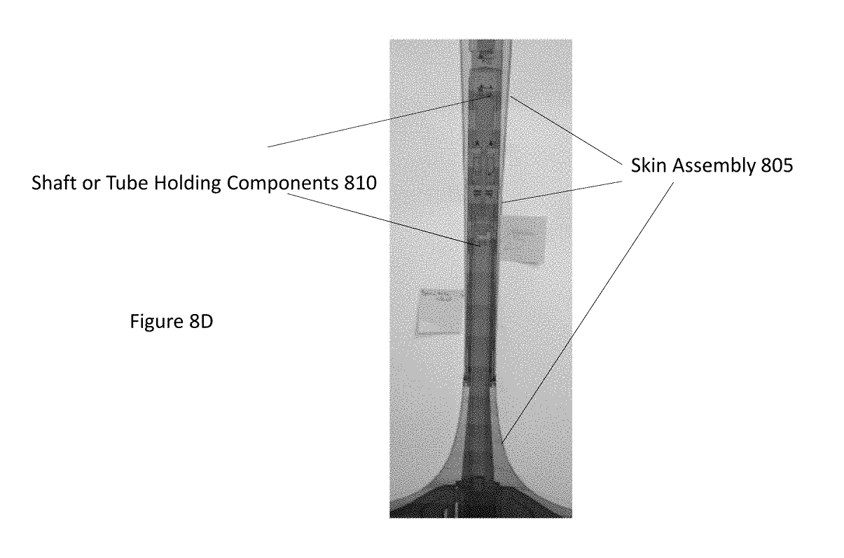

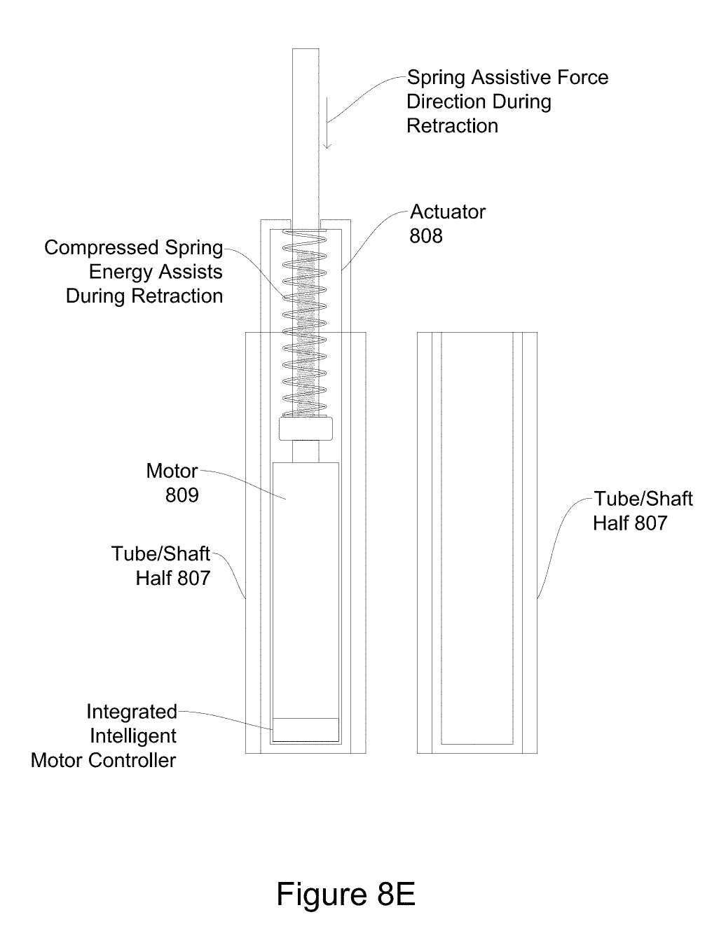

FIGS. 8A-8D illustrates a cutaway version of an intelligent umbrella having one or more skin assemblies and/or one or more shaft or tube assemblies having components installed therein according to embodiments. FIG. 8A illustrates a top section of an intelligent umbrella including one or more arms/blades. In FIG. 8A, only two arms or blades 835 are illustrated, but an intelligent umbrella and/or robotic shading system may comprise two, three, four, six or any amount of arms or blades greater than one. A top section of an intelligent umbrella may also comprise a tube or shaft section 626 and/or a tube or shaft section 625. In embodiments, tube or shaft section 626 may be one piece of material that includes tube or shaft section 625 although tube or shaft section 626 may have a smaller diameter as compared to tube or shaft section 625. In embodiment, tube or shaft section 625 may be connected, coupled, fastened, adhered and/or welded to tube or shaft section 626. In embodiments, a top section of an intelligent umbrella may comprise one or more skin assemblies and/or sections. In embodiments, one or more skin assemblies 815 may be coupled, fastened, connected and/or adhered to one or more tube or shaft sections 625 and/or 626. In embodiments, one or more skin assembly section 815 may be coupled, fastened, connected and/or adhered to another skin assembly sections 815. In embodiments, skin assembly sections may be in halves that connect to each other and/or may be comprised of three, four or five (or any number of pieces) that cover a circumference of an intelligent umbrella. In addition skin assemblies 815 may comprise a number of vertical sections, meaning that if an umbrella is, for example, 10 feet tall, there may be more than two skin assemblies that cover an entire vertical height of an intelligent umbrella (e.g., 3 skin assemblies, 10 skin assemblies, etc). In embodiments, a skin covering or assembly 820 may also cover, hide and/or protect one or more arm support and/or hinging assemblies that raise or deploy (or lower or retract) one or more arms to provide shade to a user of an intelligent umbrella. In embodiments, this provides protection from operators and/or loose objects from being caught in any moving parts of an upper section of an intelligent umbrella. In addition, the skin covering 820 of the one or more arm support and/or hinging assemblies may protect components of an upper portion of an intelligent umbrella and/or arm support and/or hinging assemblies from environmental conditions such as wind, rain, smoke and/or other dangerous materials, liquids and/or gasses. In embodiments, one or more shaft and/or tube assemblies may consist of glass filled Acrylonitrile butadiene styrene (abs) and/or polycarbonate blend. In embodiments, one or more shaft and/or tube assemblies may consist of polypropylene. In embodiments, one or more shaft and/or tube assemblies may consist of aircraft aluminum, aluminum and/or another lightweight metal. In embodiments, one or more skin assemblies 815 may be comprised of glass filled abs/polycarbonate blend or polypropylene. In embodiments, one or more skin assemblies may be made of fiberglass, nylon, carbon fiber, plastic, composite and/or any combination thereof. In embodiments, one or more arms and/or blades 835 and/or one or more arm support assemblies may be made of aircraft aluminum, a lightweight metal, glass filled abs/polycarbonate blend, polypropylene, fiberglass, plastic, composite material and/or carbon fiber. In embodiments, an intelligent umbrella and/or robotic shading system may stand approximately ten feet or eleven feet tall in a vertical direction and/or may span seven feet and/or eight feet in a horizontal direction when arms and/or blades and/or shading fabric are fully opened and/or deployed. The use of the above-identified materials along with a small diameter of the overall base assembly stem, the core assembly and upper assembly allow an intelligent umbrella with dimensions above to weigh less than seventy-five pounds and thus classified as portable by Underwriter Laboratories. Only current umbrellas utilize heavier materials and thus may not be classified as portable and be standalone with the amount of functionality of the intelligent umbrella. In addition, one or more tubes or shafts (and/or tube assemblies and/or shaft assemblies) may have different diameters depending on components and/or assemblies located within or integrated into (e.g., an interior) of the tube or shaft assemblies. Thus, the intelligent umbrella may have varying widths, due to varying diameters of tube or shaft assemblies, which may also lead to a reduced weight. For example, an intelligent umbrella may be smaller in diameter just on top of a base assembly and where motors and/or actuators may be located, whereas thicker diameters may be necessary where an integrated computing device is located and/or where an arm expansion and/or arm hinging assembly is located.

FIG. 8B illustrates an upper middle section of an intelligent umbrella including skin assemblies and/or shaft or tube assemblies according to embodiments. As shown in FIG. 8B, the top middle section has one or more skin assemblies 805. In embodiments, the top middle section has one or more shaft or tubing assemblies 810. In embodiments, the shaft and/or tubing assemblies have different diameters. In the case of the top middle section, the shaft and/or tubing assemblies have at least three different diameters (one diameter of shaft and tubing for rotating shaft and/or rod; one diameter of shaft or tubing for motor assemblies; one diameter of shaft or tubing for computer boards and/or motor control boards).

FIG. 8C illustrates a lower middle section of an intelligent umbrella including skin assemblies and/or shaft or tube assemblies according to embodiments. In embodiments, the lower middle section has one or more skin assemblies 805. In embodiments, the lower middle section has one or more shaft or tubing assemblies 810 which hold components of an intelligent umbrella. In embodiments, as is shown in FIG. 8C, there may be no tubing or shaft assembly where an elevation hinging assembly may be located.

FIG. 8D illustrates a base section of an intelligent umbrella including skin assemblies and/or shaft or tube assemblies according to embodiments. In embodiments, a base and lower section of an intelligent umbrella may include one or more skin assemblies 805. In embodiments, a base and lower section of an intelligent umbrella may include one or more shaft or tubing assemblies 810, where one of the shaft and/or tubing assemblies 810 connects, attaches or couples to a base assembly.

FIG. 8E illustrates a cutaway of a shaft and/or tube assembly of an intelligent umbrella including an actuator and/or motor assembly according to embodiments. In embodiments, a shaft and/or tube assembly may comprise two parts (although it may be a singular piece), a first tube or shaft half 806 and/or a second tube or shaft half 807. In embodiments, a first tube or shaft half 806 and/or a second tube or shaft half 807 may be manufactured or made of a plastic material, a lightweight metal, a metal, a nylon material, a composite material, or a combination of thereof. In embodiments, an actuator 808 and/or a motor assembly 809 may fit into a channel 811 of a first tube or shaft half 806 and/or a second tube or shaft half 807. In embodiments, a diameter of a shaft and/or tube assembly 805 may be determined based on an area, a length and/or a diameter of a component being placed in that section of the shaft and/or tube assembly. In other words, different tubes or shafts may have different diameters in order to fit components and/or assemblies but also to not allow for movement, slippage and/or rotation of specific assemblies. For example, while a shaft of a motor and a casing of an actuator may move, a motor itself may not move because that would damage the motor and keep it from delivering optimal efficiency. Accordingly, making a channel width large enough to fit a motor but not large enough for there to be movement of a motor is important and/or advantage over prior art umbrella systems that may just have mounted or fastened motors to umbrella frames. For example, as illustrated in FIGS. 8A-8D, different sections of the shaft and/or tube assembly in different sections of the intelligent umbrella have different lengths and/or diameters based on requirements of that section of the intelligent umbrella and components integrated therein. For example, in embodiments, if a tube or shaft assembly has a single-board computer integrated therein, that tube or shaft assembly may have a larger diameter than a section of a tube or shaft assembly housing only a motor and/or actuator.

In embodiments, instructions stored in a memory of an extension assembly and/or sensor module 410 and executable by a microcontroller 408 in the extension assembly and/or sensor module 410 may include algorithms and/or processes for determining and/or calculating a desired azimuth and/or orientation of a modular umbrella system depending on a time of day. In alternative embodiments, a microcontroller 408 in an extension assembly and/or sensor module 410 may communicate heading measurements, geographic location measurements and or time measurement to a processor 412 in a motion control module 420. In an alternative embodiment, a portable computing device executing computer-readable instructions on a processor (e.g., a SMARTSHADE software app) and located in a vicinity of a modular umbrella system may retrieve coordinates utilizing a mobile computing device's GPS transceiver and may retrieve a time from a mobile computing device's processor clock and provide these geographic location measurements and/or time to an extension assembly and/or sensor module 410 (e.g., a microcontroller)

In embodiments, computer-readable instructions stored in a memory (e.g., memory 409) of a sensor module 410 may be executed by a microcontroller 408 and may calculate 350 a desired modular umbrella system elevation angle and/or azimuth angle utilizing received geographic location measurements, heading measurements, and/or time measurements. In embodiments, a microcontroller may transfer desired elevation angle measurements and/or azimuth angle measurements to a motion control module 420. In embodiments, computer-readable instructions stored in a memory of a motion control module 420 may compare 360 desired elevation angle measurements and azimuth angle measurements to a current elevation angle and azimuth angle of the modular umbrella system (calculated from gyroscope measurements, accelerometer measurements, and/or both) to determine movements that a modular umbrella system may make in order to move to a desired orientation. In embodiments, executed computer-readable instructions may calculate an azimuth adjustment measurement to provide to an azimuth motor and/or an elevation adjustment measurement to provide to an elevation motor.

In embodiments, in response to the comparison, computer-readable instructions executed by a processor 310 may communicate 370 a command, signal, message, and/or instructions to an azimuth motor assembly to cause a modular umbrella system 100 to rotate to a desired azimuth orientation by moving an azimuth adjustment measurement. In embodiments, in response to the comparison, computer-readable instructions executed by a processor 310 may communicate 380 to an elevation motor assembly to cause an upper core assembly to rotate with to a desired angle with respect to a lower core assembly (e.g., a desired elevation angle) by moving an elevation adjustment measurement.

In embodiments, in response to reaching a desired elevation angle and/or azimuth angle, computer-readable instructions executed by a processor may start 385 a timer (and/or clock) and after a predetermined time (or time threshold) may re-initiate 390 the modular umbrella orientation positioning process described above. In embodiments, a modular umbrella orientation positioning process may be reinitiated and/or checked every 5 to 7 minutes. In embodiments, a modular umbrella orientation positioning process may be initiated when a modular umbrella system is turned on and/or reset. In embodiments, adjustments may not be made every time a modular umbrella orientation positioning process is initiated because a modular umbrella system may not have moved significantly in a measurement timeframe.

A computing device may be a server, a computer, a laptop computer, a mobile computing device, a mobile communications device, and/or a tablet. A computing device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

Internal architecture of a computing device includes one or more processors (also referred to herein as CPUs), which interface with at least one computer bus. Also interfacing with computer bus are persistent storage medium/media, network interface, memory, e.g., random access memory (RAM), run-time transient memory, read only memory (ROM), etc., media disk drive interface, an interface for a drive that can read and/or write to media including removable media such as floppy, CD-ROM, DVD, etc., media, display interface as interface for a monitor or other display device, keyboard interface as interface for a keyboard, mouse, trackball and/or pointing device, and other interfaces not shown individually, such as parallel and serial port interfaces, a universal serial bus (USB) interface, and the like.

Memory, in a computing device and/or a modular umbrella shading system, interfaces with computer bus so as to provide information stored in memory to processor during execution of software programs such as an operating system, application programs, device drivers, and software modules that comprise program code or logic, and/or computer-executable process steps, incorporating functionality described herein, e.g., one or more of process flows described herein. CPU first loads computer-executable process steps or logic from storage, storage medium/media, removable media drive, and/or other storage device. CPU can then execute the stored process steps in order to execute the loaded computer-executable process steps. Stored data, e.g., data stored by a storage device, can be accessed by CPU during the execution of computer-executable process steps.

Non-volatile storage medium/media is a computer readable storage medium(s) that can be used to store software and data, e.g., an operating system and one or more application programs, in a computing device or storage subsystem of an intelligent shading object. Persistent storage medium/media also be used to store device drivers, such as one or more of a digital camera driver, monitor driver, printer driver, scanner driver, or other device drivers, web pages, content files, metadata, playlists and other files. Non-volatile storage medium/media can further include program modules/program logic in accordance with embodiments described herein and data files used to implement one or more embodiments of the present disclosure.

A computing device or a processor or controller may include or may execute a variety of operating systems, including a personal computer operating system, such as a Windows, iOS or Linux, or a mobile operating system, such as iOS, Android, or Windows Mobile, Windows Phone, Google Phone, Amazon Phone, or the like. A computing device, or a processor or controller in an intelligent shading controller may include or may execute a variety of possible applications, such as a software applications enabling communication with other devices, such as communicating one or more messages such as via email, short message service (SMS), or multimedia message service (MMS), including via a network, such as a social network, including, for example, Facebook, LinkedIn, Twitter, Flickr, or Google+, to provide only a few possible examples. A computing device or a processor or controller in an intelligent shading object may also include or execute an application to communicate content, such as, for example, textual content, multimedia content, or the like. A computing device or a processor or controller in an intelligent shading object may also include or execute an application to perform a variety of possible tasks, such as browsing, searching, playing various forms of content, including locally stored or streamed content. The foregoing is provided to illustrate that claimed subject matter is intended to include a wide range of possible features or capabilities. A computing device or a processor or controller in an intelligent shading object may also include imaging software applications for capturing, processing, modifying and transmitting image files utilizing the optical device (e.g., camera, scanner, optical reader) within a mobile computing device.

Network link typically provides information communication using transmission media through one or more networks to other devices that use or process the information. For example, network link may provide a connection through a network (LAN, WAN, Internet, packet-based or circuit-switched network) to a server, which may be operated by a third party housing and/or hosting service. For example, the server may be the server described in detail above. The server hosts a process that provides services in response to information received over the network, for example, like application, database or storage services. It is contemplated that the components of system can be deployed in various configurations within other computer systems, e.g., host and server.

For the purposes of this disclosure a computer readable medium stores computer data, which data can include computer program code that is executable by a computer, in machine-readable form. By way of example, and not limitation, a computer-readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

1. A method of orienting an umbrella, comprising:
obtaining a current location for an umbrella and communicate the current location to one or more processors;
capturing a current time of day via a clock in the umbrella and communicating the current time to the one or more processors;
calculating an elevation angle and azimuth angle of a sun utilizing the current time and the location;
capturing a reading from a compass in the umbrella to determine a directional heading or an angular heading for a top section of the umbrella; and
rotating a core assembly and an upper assembly of the umbrella about a base of the umbrella.

2. The method of claim 1, wherein obtaining the current location for the umbrella comprises utilizing a global positioning system (GPS) sensor to obtain a location measurement.

3. The method of claim 1, wherein obtaining the current location for the umbrella comprises utilizing one or more wireless communication transceiver communicating with wireless access points to determine the current location.

4. The method of claim 3, wherein obtaining the current location for the umbrella comprises utilizing radio signal strength indicator (RSSI) measurements to determine the current location.

5. The method of claim 1, further comprising utilizing a sensor assembly to detect a location of a magnet in the base of the umbrella.

6. The method of claim 5, further comprising aligning a top of umbrella with the magnet in the base of the umbrella.

7. The method of claim 6, further comprising receiving a compass measurement from a mobile computing device in order to determine a directional reference point.

8. The method of claim 7, further comprising orienting the base of the umbrella based, at least in part, of the received compass measurement.
